(19) United States
(12) Patent Application Publication
(10) Pub. No.: US 2017/0195385 A1
(43) Pub. Date: Jul. 6, 2017

(54) METHOD AND ELECTRONIC DEVICE FOR PLAYING VIDEO

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiong Wang, Beijing (CN)

(21) Appl. No.: 15/243,836

(22) Filed: Aug. 22, 2016

Related U.S. Application Data
(63) Continuation of application No. PCT/CN2016/089000, filed on Jul. 6, 2016.

(30) Foreign Application Priority Data
Dec. 31, 2015 (CN) 201511026816.2

(51) Int. Cl. H04L 29/06; H04W 36/14; H04L 12/707; H04W 76/02

(52) U.S. Cl. CPC H04L 65/4084; H04W 76/02; H04W 36/14; H04L 45/24; H04W 84/042

(57) ABSTRACT

The present application discloses a method and an electronic device for playing video. The method includes the following. A network connection manner is acquired in real time while at least two paths of videos are being played; and a playing operation of the videos is suspended and prompt information is sent simultaneously after delaying for a preset period of time if it is identified that the network connection manner is a mobile network connection.

### CROSS-REFERENCES TO RELATED APPLICATIONS

The present application is a continuation application of a PCT application No. PCT/CN2016/089000, filed on Jul. 6, 2016, which claims the priority from Chinese patent application No. 201511026816.2, titled “Method and Device for Playing Video”, filed on Dec. 31, 2015 to State Intellectual Property Office, the content of both applications is herein incorporated by reference.

### TECHNICAL FIELD

The present application relates to computer technologies, and for example, relate to a method and an electronic device for playing video.

### BACKGROUND

With developments of Internet technologies, it is very common for a terminal equipment to perform video playing locally after acquiring video information through a network. Network connection manners used by a terminal equipment during video playing mainly include wifi network connection and mobile network connection. In most cases, there is no traffic limitation and additional costs when using a wifi network connection. However, traffic purchased by a user is consumed when using a mobile network connection, and additional costs should be paid when continuing playing videos after the purchased traffic is used up.

In a process of realizing the present application, inventors discovered that at least following problems exist in the related art. When a terminal equipment plays videos by using multiple paths of video streams simultaneously, and a used network connection manner is a mobile network connection, the user would use purchased traffic to play videos, while a player itself does not take any effective measure to avoid this situation; and meanwhile, in a process of playing multiple paths of videos in a mobile network environment, a good user experience is failed to be provided for the user.

### SUMMARY

The present application provides a method and an electronic device for playing video, so as to prevent a user from using purchased traffic to play videos, and bring good user experience as well when video playing is conducted on multiple paths of video streams simultaneously in a mobile network connection manner.

In a first aspect, embodiments of the present application provide a method for playing video, including:

acquiring a network connection manner in real time while at least two paths of videos are being played; and

suspending a playing operation of the videos and sending prompt information simultaneously after delaying for a preset period of time if it is identified that the network connection manner is a mobile network connection.

In a second aspect, embodiments of the present application further provide an electronic device for playing video, including: at least one processor; and a memory communicably connected with the at least one processor for storing instructions executable by the at least one processor, wherein execution of the instructions by the at least one processor causes the at least one processor to:

acquire a network connection manner in real time while at least two paths of videos are being played; and

suspend a playing operation of the videos and send prompt information simultaneously after delaying for a preset period of time if it is identified that the network connection manner is a mobile network connection.

In a third aspect, embodiments of the present application further provide a non-transitory computer-readable storage medium storing executable instructions that, when executed by an electronic device, cause the electronic device to:

acquire a network connection manner in real time while at least two paths of videos are being played; and

suspend a playing operation of the videos and send prompt information simultaneously after delaying for a preset period of time if it is identified that the network connection manner is a mobile network connection.

### DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram showing a method for playing video provided in embodiment 1 of the present application;

FIG. 2 is a flow diagram showing a method for playing video provided in embodiment 2 of the present application;

FIG. 3 is a flow diagram showing a method for playing video provided in embodiment 3 of the present application;

FIG. 4 is a flow diagram showing a method for playing video provided in embodiment 4 of the present application;

FIG. 5 is a flow diagram showing a method for playing video provided in embodiment 5 of the present application;

FIG. 6 is a flow diagram showing a method for playing video provided in embodiment 6 of the present application;

FIG. 7 is a flow diagram showing a method for playing video provided in embodiment 7 of the present application;

FIG. 8 is a structural diagram showing a device for playing video provided in embodiment 8 of the present application; and

FIG. 9 is a functional block diagram showing a hardware structure of an equipment provided in embodiment 10 of the present application.

### DETAILED DESCRIPTION

The present application will be described in detail below in combination with the drawings and the embodiments. It should be understood that embodiments described herein are only used for explaining the present application, not used for limiting the present application. In addition, it should be noted that for ease of description, the Figures only show some structures related to the present application rather than all structures.

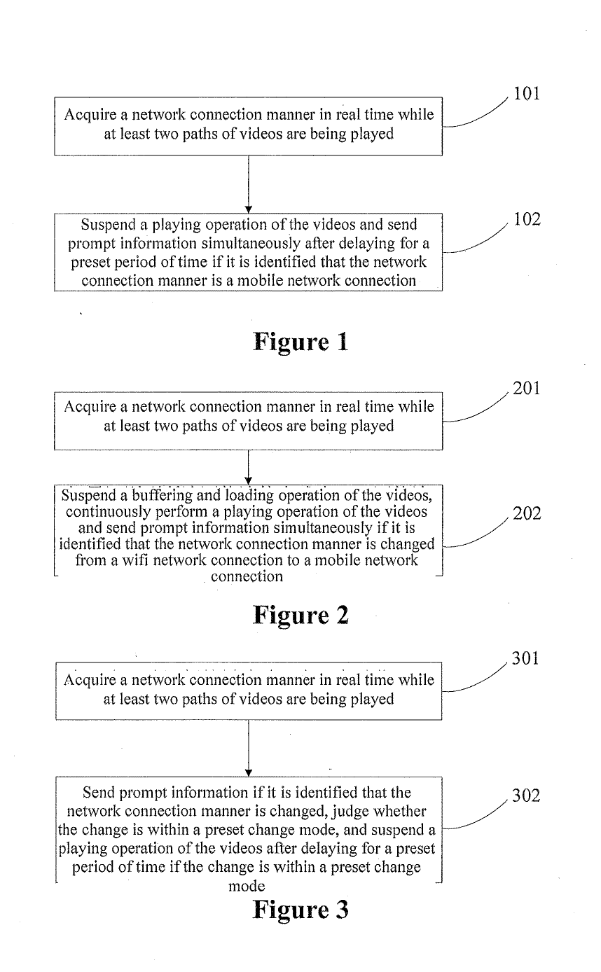

FIG. 1 is a flow diagram showing a method for playing video provided in embodiment 1 of the present application. This embodiment is suitable for a situation of playing multiple paths of videos in a smart terminal equipment by using a network, and the method may be executed through a smart terminal equipment such as a smart cellphone, a tablet computer and a laptop. The method includes following steps.

In Step 101, a network connection manner is acquired in real time while at least two paths of videos are being played;

where the network connection manner may typically include a wifi network connection and a mobile network connection. Generally, traffic in the wifi network connection is free to use, and as an example, a smart terminal equipment conducts wifi network connection through a router in a house, the router may simultaneously access a plurality of smart terminal equipments, and no additional cost is needed to pay when each of the smart terminal equipments acquires network traffic through the router. The mobile network connection includes 2G, 3G and 4G network connection, etc. Generally, costs for traffic are needed to be paid when a smart terminal equipment acquires network traffic by using a mobile network, as an example, a user generally needs to purchase a traffic packet of a certain size when the smart terminal equipment acquires traffic to play videos through a 4G network, and the smart terminal equipment acquires traffic by using a 4G mobile network in a place where no wifi network connection is provided. The smart terminal equipment would acquire a network connection manner thereof in real time while videos are being played, and the acquired network connection manner may be used for a judgement process in a next step, where there may be three paths of videos simultaneously displaying and playing.

In Step 102, a playing operation of the videos is suspended and prompt information is sent simultaneously after delaying for a preset period of time if it is identified that the network connection manner is a mobile network connection;

where a buffering operation and the playing operation of the videos are synchronously conducted while multiple paths of videos are being played, that is, the buffering operation of the videos is suspended while the playing operation of the videos is suspended. Generally, a buffering speed would be higher than a playing speed of the videos. During the buffering operation, the smart terminal equipment conducts data exchange with other terminal equipments, such as a server, through a network, and at this moment, network traffic would be consumed. The playing operation of the at least two paths of videos is suspended and prompt information is sent simultaneously after delaying for a preset period of time if it is identified that the smart terminal equipment is connected in the mobile network connection manner when playing multiple paths of videos, and the preset period of time may be selected as 10 seconds. In this embodiment, if the network connection manner is a mobile network connection, the playing is stopped after delaying for a preset period of time rather than being stopped immediately, so as to provide a user with an experience of playing multiple paths of video streams in a mobile network environment.

In technical solutions of this embodiment, a network connection manner is acquired in real time while at least two paths of videos are being played, and the playing operation of the videos is suspended and prompt information is sent simultaneously after delaying for a preset period of time if it is identified that the network connection manner is a mobile network connection, so as to prevent a user from using purchased traffic to play videos and bring good user experience as well when video playing is conducted on multiple paths of video streams simultaneously in a mobile network connection manner.

In the above-mentioned solution, optionally, identifying that the network connection manner is a mobile network connection, includes: identifying that the network connection manner is changed from none network connection to a mobile network connection.

In the above-mentioned solution, optionally, identifying that the network connection manner is a mobile network connection, includes: identifying that the network connection manner is changed from a wifi network connection to a mobile network connection.

FIG. 2 is a flow diagram showing a method for playing video provided in embodiment 2 of the present application. This embodiment is optimized on the basis of the above-mentioned embodiment. The method includes following steps.

In Step 201, a network connection manner is acquired in real time while at least two paths of videos are being played.

In Step 202, a buffering and loading operation of the videos is suspended, a playing operation of the videos is continuously performed and prompt information is sent simultaneously if it is identified that the network connection manner is changed from a wifi network connection to a mobile network connection.

In this step, the buffering and loading operation of the videos is suspended, the playing operation of the videos is continuously performed and prompt information is sent simultaneously if it is identified that the network connection manner is changed from a wifi network connection to a mobile network connection. As described in embodiment 1, generally, a video buffering speed would be higher than a video playing speed; and, generally, a part of video information is cached in a video buffering area when multiple paths of videos are played in the wifi network connection, therefore only the buffering is needed to be suspended and playing of the videos may be continued until playing of the video information cached in the buffering area is completed when the network connection manner is changed to a mobile network connection.

In technical solutions of this embodiment, a network connection manner is acquired in real time while at least two paths of videos are being played, and the buffering and loading operation of the videos is suspended and the playing operation of the videos is continuously performed and prompt information is sent simultaneously if it is identified that the network connection manner is changed from a wifi network connection to a mobile network connection, thereby avoiding a situation in which the playing is suspended since a connection manner is changed to a mobile network connection although a part of video information is already cached in a video buffering area.

In the above-mentioned solution, optionally, the preset period of time and the prompt information are set according to an instruction input by a user.

In the above-mentioned solution, optionally, after the playing operation of the videos is suspended, it is further included that: a default buffering duration of the videos is changed.

FIG. 3 is a flow diagram showing a method for playing video provided in embodiment 3 of the present application. This embodiment is optimized on the basis of the above-mentioned embodiment, that is, an operation for identifying a change mode of the network connection manner is added. The method includes following steps.

In Step 301, a network connection manner is acquired in real time while at least two paths of videos are being played.

where the network connection manners include a wifi network connection, a mobile network connection, etc., and the mobile network connection includes different network connections such as 2G, 3G and 4G.

In Step 302, prompt information is sent if it is identified that the network connection manner is changed, it is judged whether the change is within a preset change mode, and a playing operation of the videos is suspended after delaying for a preset period of time if the change is within a preset change mode;

where the prompt information is sent when the network connection manner is changed, the change of the network connection manner includes: the wifi network connection is disconnected, the wifi network connection is established, the mobile network connection is disconnected, the mobile network connection is established, the wifi network connection is changed to the mobile network connection, the mobile network connection is changed to the wifi network connection, a free wifi network connection is changed to a pay wifi network connection, the pay wifi network connection is changed to the free wifi network connection, etc. Corresponding prompt is performed through corresponding prompt information according to changes of different network connection modes. A judgement is conducted on whether the change of the network connection mode is within a preset change mode when the network connection mode is changed, where the preset change mode is generally a mode changing from a free network connection to a pay network connection, such as “the wifi network connection is changed to the mobile network connection”, “the free wifi network connection is changed to the pay wifi network connection”, etc. The playing operation of the videos is suspended after delaying for a preset period of time when the change of the network connection mode is within a preset change mode.

In technical solutions of this embodiment, a network connection manner is acquired in real time while at least two paths of videos are being played, prompt information is sent and it is judged whether the change is within a preset change mode if it is identified that the network connection manner is changed, and the playing operation of the videos is suspended after delaying for a preset period of time when the change is within a preset change mode, so that it is achieved that related information about the change of the network connection mode can be displayed in real time while multiple paths of videos are being played.

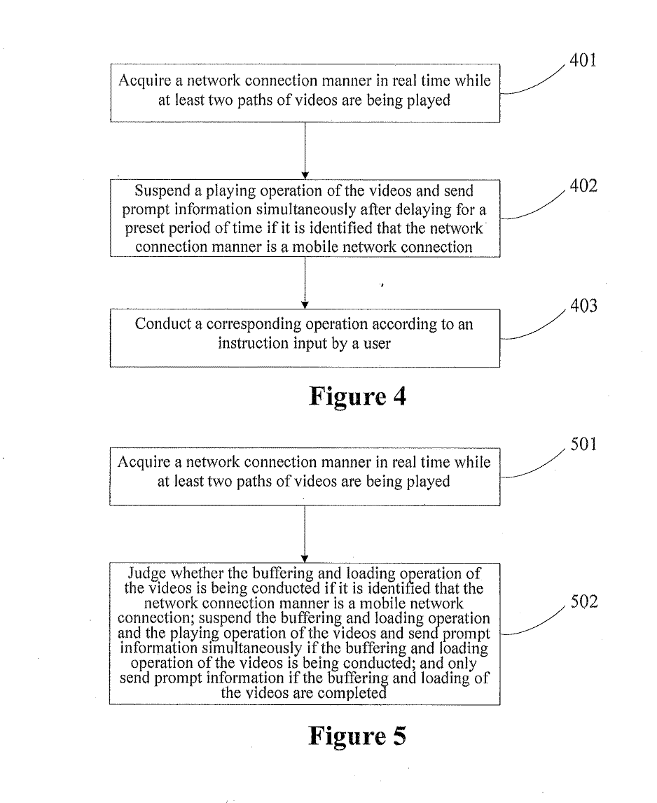

FIG. 4 is a flow diagram showing a method for playing video provided in embodiment 4 of the present application. This embodiment is optimized on the basis of the above-mentioned embodiment, that is, content that a user conducts control is added. The method includes following steps.

In Step 401, a network connection manner is acquired in real time while at least two paths of videos are being played.

In Step 402, a playing operation of the videos is suspended and prompt information is sent simultaneously after delaying for a preset period of time if it is identified that the network connection manner is a mobile network connection.

The playing operation of the videos is suspended and prompt information is sent simultaneously after delaying for a preset period of time if it is identified that the network connection manner is a mobile network connection. The prompt information may be “a pay traffic mode is entered, the video playing is suspended, and whether to continuously perform the playing”.

In Step 403, a corresponding operation is conducted according to an instruction input by a user.

As described in step 402, the prompt information is “a pay traffic mode is entered, the video playing is suspended, and whether to continuously perform the playing”, and the video playing operation is enabled correspondingly if the user selects “yes”. If the user selects “no”, the video playing operation remains in a suspension state.

In technical solutions of this embodiment, a network connection manner is acquired in real time while multiple paths of videos are being played, and the playing operation of the videos is suspended and prompt information is sent simultaneously for the user to perform subsequent operations according to the prompt information, after delaying for a preset period of time if it is identified that the network connection manner is a mobile network connection, so that it is achieved while multiple paths of videos are being played that the user can conduct corresponding selection according to requirements of the user after learning that the network connection manner is a mobile network connection.

FIG. 5 is a flow diagram showing a method for playing video provided in embodiment 5 of the present application. This embodiment is optimized on the basis of the above-mentioned embodiment, that is, the playing operation of videos is distinguished from the buffering and loading operation, and an operation of identifying a loading progress is added. The method includes following steps.

In Step 501, a network connection manner is acquired in real time while at least two paths of videos are being played.

In Step 502, it is judged whether the buffering and loading operation of the videos is being conducted if it is identified that the network connection manner is a mobile network connection; the buffering and loading operation and the playing operation of the videos are suspended and prompt information is sent simultaneously if the buffering and loading operation of the videos is being conducted; and only prompt information is sent if the buffering and loading of the videos are completed.

It is judged whether the buffering and loading operation of the videos is being conducted if it is identified that the network connection manner is a mobile network connection, and as described in the above-mentioned embodiment, the buffering and loading operation and the playing operation of the videos are suspended and prompt information is sent simultaneously if the buffering and loading operation of the videos is being conducted at this moment. If the buffering of the videos is completed, there is no need to suspend the buffering and loading operation and the playing operation of the videos, and only prompt information about the change of a corresponding network connection manner is sent.

In technical solutions of this embodiment, a network connection manner is acquired in real time while at least two paths of videos are being played, and it is judged whether the buffering and loading operation of the videos is being conducted if it is identified that the network connection manner is a mobile network connection; the buffering and loading operation and the playing operation of the videos are suspended and prompt information is sent simultaneously if the buffering and loading operation of the videos is being conducted; and only prompt information is sent if the buffering and loading of the videos are completed. The judgement on whether the buffering operation is being conducted is added into suspension control, thereby avoiding occurring of a situation in which the playing operation is suspended in case that no traffic would be consumed due to completion of the video buffering.

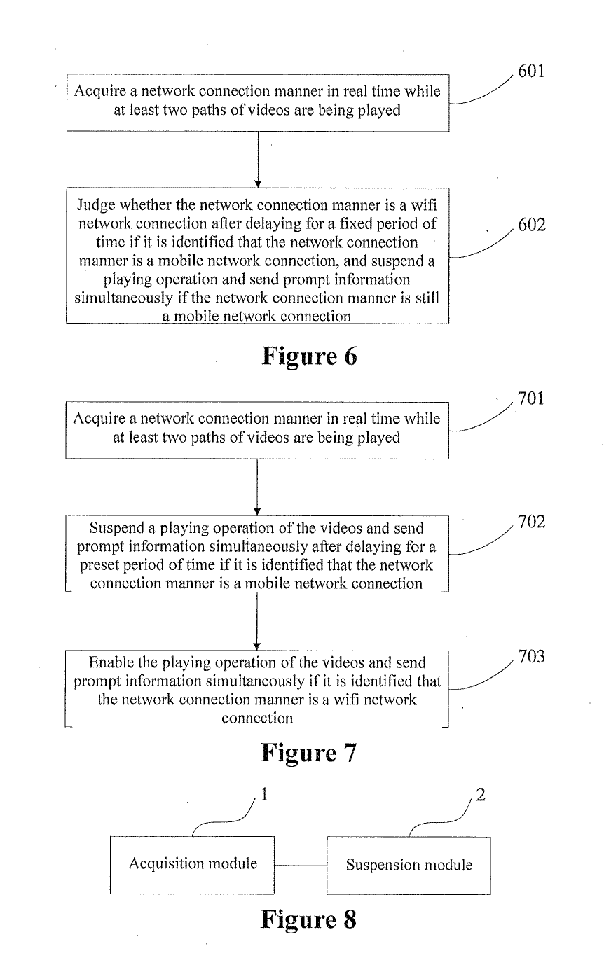

FIG. 6 is a flow diagram showing a method for playing video provided in embodiment 6 of the present application. This embodiment is optimized on the basis of the above-mentioned embodiment, that is, an operation of recovering a playing process is added. The method includes following steps.

In Step 601, a network connection manner is acquired in real time while at least two paths of videos are being played.

In Step 602, it is judged whether the network connection manner is a wifi network connection after delaying for a fixed period of time if it is identified that the network connection manner is a mobile network connection, and a playing operation is suspended and prompt information is sent simultaneously if the network connection manner is still a mobile network connection.

The playing operation of the videos is continuously performed if it is identified that the network connection manner is a mobile network connection.

It is judged whether the network connection manner is a wifi network connection after delaying for a fixed period of time, and the playing operation is suspended and prompt information is sent simultaneously if the network connection manner is still a mobile network connection. The fixed period of time may be set as 5 seconds, and there is no need to suspend the playing operation of the videos after delaying for a preset period of time if it is identified within 5 seconds that the network connection manner is not a wifi network connection. There is no need to suspend the playing operation of the videos if the network connection manner is changed to a wifi network connection within the fixed period of time.

In technical solutions of this embodiment, a network connection manner is acquired in real time while multiple paths of videos are being played, it is judged whether the network connection manner is a wifi network connection after delaying for a fixed period of time if it is identified that the network connection manner is a mobile network connection, and the playing operation is suspended and prompt information is sent simultaneously if the network connection manner is still a mobile network connection, where a fixed period of time is set simultaneously, and there is no need to suspend the playing of the videos if the network connection manner is changed to a wifi network connection within the fixed period of time, thereby improving user experience.

FIG. 7 is a flow diagram showing a method for playing video provided in embodiment 7 of the present application. This embodiment is optimized on the basis of the above-mentioned embodiment, that is, content of further recovering playing after the playing is suspended is added. The method includes following steps.

In Step 701, a network connection manner is acquired in real time while at least two paths of videos are being played.

In Step 702, a playing operation of the videos is suspended and prompt information is sent simultaneously after delaying for a preset period of time if it is identified that the network connection manner is a mobile network connection.

In Step 703, the playing operation of the videos is enabled and prompt information is sent simultaneously if it is identified that the network connection manner is a wifi network connection.

In this step, optionally based on the above-mentioned solution, a buffering and loading operation and the playing operation of the videos are enabled and prompt information is sent simultaneously if it is identified that the network connection manner is recovered.

In technical solutions of this embodiment, a network connection manner is acquired in real time while multiple of paths of videos are being played; the playing operation of the videos is suspended and prompt information is sent simultaneously after delaying for a preset period of time if it is identified that the network connection manner is a mobile network connection; and the playing operation of the videos is enabled and prompt information is sent simultaneously if it is identified that the network connection manner is a wifi network connection, so that it is achieved that the playing of videos can be automatically enabled according to changes of the network connection manner while the videos are being played.

FIG. 8 is a structural diagram showing a device for playing video provided in embodiment 8 of the present application. As shown in FIG. 8, the device includes:

an acquisition module 1, which is configured to acquire a network connection manner in real time while at least two paths of videos are being played; and

a suspension module 2, which is configured to suspend a playing operation of the videos and send prompt information simultaneously after delaying for a preset period of time if it is identified that the network connection manner is a mobile network connection.

In the above-mentioned solution, optionally; the suspension module 2 is configured for:

suspending the playing operation of the videos and sending prompt information simultaneously after delaying for a preset period of time if it is identified that the network connection manner is changed from none network connection to a mobile network connection.

In the above-mentioned solution, optionally, the suspension module 2 is configured for:

suspending the playing operation of the videos and sending prompt information simultaneously after delaying for a preset period of time if it is identified that the network connection manner is changed from a wifi network connection to a mobile network connection.

In the above-mentioned solution, optionally, the acquisition module 1 is configured for:

setting the preset period of time and the prompt information according to an instruction input by a user.

In the above-mentioned solution, optionally, the suspension module 2 is configured for:

changing a default buffering duration of the videos.

The above-mentioned product can execute the method provided in any embodiment of the present application, and has corresponding function modules for executing the method.

Embodiments of the present application provide a non-transitory computer storage medium in which a computer executable instruction is stored, and the computer executable instruction can execute the method for playing video in any of the above-mentioned method embodiments.

### Embodiment 10

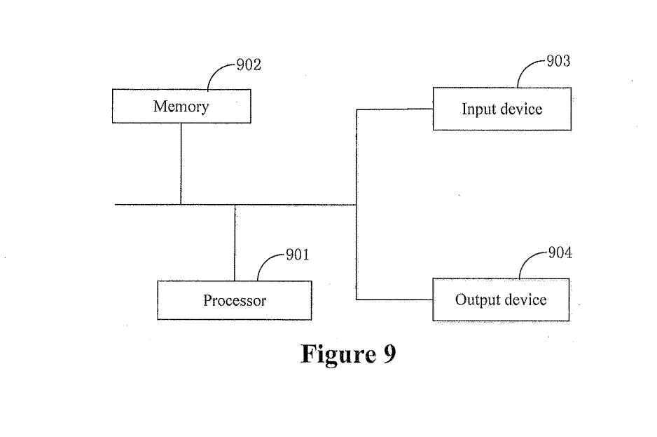

FIG. 9 is a functional block diagram showing a hardware structure of an equipment for executing a method for playing video provided in embodiment 10 of the present application. As shown in FIG. 9, the equipment includes:

at least one processor 901 and a memory 902, where one processor 901 is taken as an example in FIG. 9.

The equipment may further include: an input device 903 and an output device 904.

The processor 901, the memory 902, the input device 903 and the output device 904 in the equipment may be connected by a bus or in other manners, and a connection through the bus is taken as an example in FIG. 9.

As a non-transitory computer readable storage medium, the memory 902 may be used for storing non-transitory software programs, non-transitory computer executable programs and modules, such as program instructions/modules (for example, the acquisition module 1 and the suspension module 2 shown in FIG. 8) corresponding to the method for playing video in embodiments of the present application. The processor 901 executes various function applications and data processing of a server by operating non-transitory software programs, instructions and modules stored in the memory 902, that is, the method for playing video in the above-mentioned method embodiments is realized.

The memory 902 may include a program storage area and a data storage area, where the program storage area can store an operating system, and an application program required by at least one function; and the data storage area can store data created by use of the terminal equipment. In addition, the memory 902 may include a high-speed random access memory, and may further include a non-transitory memory such as at least one magnetic disk storage device, a flash memory device or other non-transitory solid-state storage devices. In some embodiments, optionally, the memory 902 may include memories remotely arranged relative to the processor 901, where these remote memories can be connected to the terminal equipment through a network. Examples of the above-mentioned network include but are not limited to an Internet, an Intranet, a local area network, a mobile communication network and a combination thereof.

The input device 903 may be used for receiving input digit or character information, and producing key signal input related to user setting and function control of a terminal. The output device 904 may include a display equipment such as a display screen.

The at least one module is stored in the memory 902, and executes the method for playing video in any of the above-mentioned method embodiments when executed by the at least one processor 901.

The above-mentioned product may execute the method provided in embodiments of the present application, and has a corresponding function module for executing the method and beneficial effects. See the method provided in embodiments of the present application for technical details not described in this embodiment in detail.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile Internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement dose not make essential of corresponding technical solutions depart from spirits and scope of technical solutions of various embodiments.

What is claimed is:

1. A method for playing video, comprising:
acquiring a network connection manner in real time while at least two paths of videos are being played; and
suspending a playing operation of said videos and sending prompt information simultaneously after delaying for a preset period of time if it is identified that said network connection manner is a mobile network connection.

2. The method for playing video according to claim 1, wherein the identifying that said network connection manner is a mobile network connection comprises:
identifying that said network connection manner is changed from none network connection to a mobile network connection.

3. The method for playing video according to claim 1, wherein the identifying that said network connection manner is a mobile network connection comprises:
identifying that said network connection manner is changed from a wife network connection to a mobile network connection.

4. The method for playing video according to claim 1, further comprising:
setting said preset period of time and said prompt information according to an instruction input by a user.

5. The method for playing video according to claim 1, after the playing operation of said videos is suspended, further comprising:
changing a default buffering duration of said videos.

6. An electronic device for playing video, comprising:
at least one processor; and
a memory communicably connected with the at least one processor for storing instructions executable by the at least one processor, wherein execution of the instructions by the at least one processor causes the at least one processor to:
acquire a network connection manner in real time while at least two paths of videos are being played, and
suspend a playing operation of said videos and send prompt information simultaneously after delaying for a preset period of time if it is identified that said network connection manner is a mobile network connection.

7. The electronic device for playing video according to claim 6, wherein, the execution of the instructions by the at least one processor further causes the at least one processor to:
suspend the playing operation of said videos and send prompt information simultaneously after delaying for a preset period of time if said network connection manner is identified to have changed from none network connection to a mobile network connection.

8. The electronic device for playing video according to claim 6, wherein, the execution of the instructions by the at least one processor further causes the at least one processor to:
suspend the playing operation of said videos and send prompt information simultaneously after delaying for a preset period of time if said network connection manner is identified to have changed from a wife network connection to a mobile network connection.

9. The electronic device for playing video according to claim 6, wherein, the execution of the instructions by the at least one processor further causes the at least one processor to:
set said preset period of time and said prompt information according to an instruction input by a user.

10. The electronic device for playing video according to claim 6, wherein, the execution of the instructions by the at least one processor further causes the at least one processor to:
change a default buffering duration of said videos.

11. A non-transitory computer-readable storage medium storing executable instructions that, when executed by an electronic device, cause the electronic device to:
acquire a network connection manner in real time while at least two paths of videos are being played; and
suspend a playing operation of said videos and send prompt information simultaneously after delaying for a preset period of time if said network connection manner is identified to be a mobile network connection.

12. The non-transitory computer-readable storage medium according to claim 11, wherein, the executable instructions further cause the electronic device to:
suspend the playing operation of said videos and send prompt information simultaneously after delaying for a preset period of time if said network connection manner is identified to have changed from none network connection to a mobile network connection.

13. The non-transitory computer-readable storage medium according to claim 11, wherein, the executable instructions further cause the electronic device to:
suspend the playing operation of said videos and send prompt information simultaneously after delaying for a preset period of time if said network connection manner is identified to have changed from a wifi network connection to a mobile network connection.

14. The non-transitory computer-readable storage medium according to claim 11, wherein, the executable instructions further cause the electronic device to:
set said preset period of time and said prompt information according to an instruction input by a user.

15. The non-transitory computer-readable storage medium according to claim 11, wherein, the executable instructions further cause the electronic device to:
change a default buffering duration of said videos.
